(19) United States
(12) Patent Application Publication
(10) Pub. No.: US 2014/0376570 A1
(43) Pub. Date: Dec. 25, 2014

(54) SYSTEMS AND METHODS FOR SELF-CHECKING PAIR

(71) Applicant: Honeywell International Inc., Morristown, NJ (US)

(72) Inventors: Scott Gray, Peoria, AZ (US); Nicholas Wilt, Glendale, AZ (US)

(21) Appl. No.: 13/924,902

(22) Filed: Jun. 24, 2013

(51) Int. Cl. H04L 7/00

(52) U.S. Cl. CPC H04L 7/0016
USPC 370/509

(57) ABSTRACT

Systems and methods for a self-checking pair are provided. In certain embodiments a system on chip in a self-checking pair includes a system architecture; a plurality of communication channels configured for communicating data with an external system; and an integrated system on chip logic configured to collect the data communicated through the plurality of communication channels and transmit the data to a second system on chip and handle received data from the second system on chip, wherein the integrated system on chip logic determines whether the data communicated through the plurality of communication channels matches the received data from the second system on chip.

### BACKGROUND

System-on-chips (SoCs) have increased in speed and are able to provide multiple interfaces, such as PCIe, Spacewire, Ethernet, and high speed local parallel busses. When the SoCs are arranged in a self-checking pair (SCP) and perform lock-step processing, the outputs for the different interfaces are compared and the inputs are synchronized. For communication during lock-step processing, only one or two of the multiple interfaces of an SoC are used. Further, each of the interfaces has an associated comparison mechanism and implements separate synchronization methods. For example, for an Ethernet interface the synchronization method may exchange MAC to PHY interface signals (such as RMII, SGMII, etc.) to compare the output signals and may include extra signaling to synchronize the inputs. In another example, a PCIe interface may exchange packets through another interface or other external components from the SCP pair of SOCs so that comparisons and synchronization could be performed.

### SUMMARY

Systems and methods for a self-checking pair are provided. In certain embodiments a system on chip in a self-checking pair includes a system architecture; a plurality of communication channels configured for communicating data with an external system; and an integrated system on chip logic configured to collect the data communicated through the plurality of communication channels and transmit the data to a second system on chip and handle received data from the second system on chip, wherein the integrated system on chip logic determines whether the data communicated through the plurality of communication channels matches the received data from the second system on chip.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of an exemplary external interface for an SoC in one embodiment described in the present disclosure;

FIG. 2 is a block diagram of an exemplary SCP in one embodiment described in the present disclosure; and

FIG. 3 is a flow diagram of an exemplary method for synchronizing separate SoCs in an SCP in one embodiment described in the present disclosure.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

Embodiments disclosed in the present disclosure synchronize and compare data across multiple interfaces. In at least one embodiment, a method for comparing and synchronizing data across multiple interfaces includes collecting the data from the various external interfaces of an SoC (PCIe, SRIO, Spacewire, Ethernet, parallel bus) between the internal parallel MAC layer and the internal serialization layer (if applicable) or internal PHY layer (if applicable) prior to entering/leaving the SoC. The outgoing data is routed (in parallel to the interfaces' normal destination paths) to an integrated SCP logic that captures and buffers the data within one or more FIFO buffers. In one particular implementation, outgoing data streams for each interface type are captured in separate FIFO buffers. The integrated SCP logic synchronizes these streams and prioritizes them based on attributes such as size and bandwidth. Output data is sent to the other SoC in the SCP through an interface, such as high speed serial (preferred), or parallel bus, wherein the incoming data stream from the other SoC is received and is also placed in FIFO buffers. Comparison logic checks the data received from the other SoC with the data from the outgoing data FIFO buffers. Any mis-comparison of the data is reported as an interrupt and disables external outputs of the SoC that were being compared. In certain implementations, a signal to the other side's SoC is sent to inhibit the cross-side external outputs as well.

Additionally, in some embodiments, input data streams of the external interfaces are synchronized to be received at the same time by the processor(s) through use of cross-side signaling to synchronize the data streams. In at least one implementation, all internal to the SoC data bus accesses by the processor(s) to the external interface data buffers (or direct access) first require synchronization of the accesses with the other SoC in the SCP.

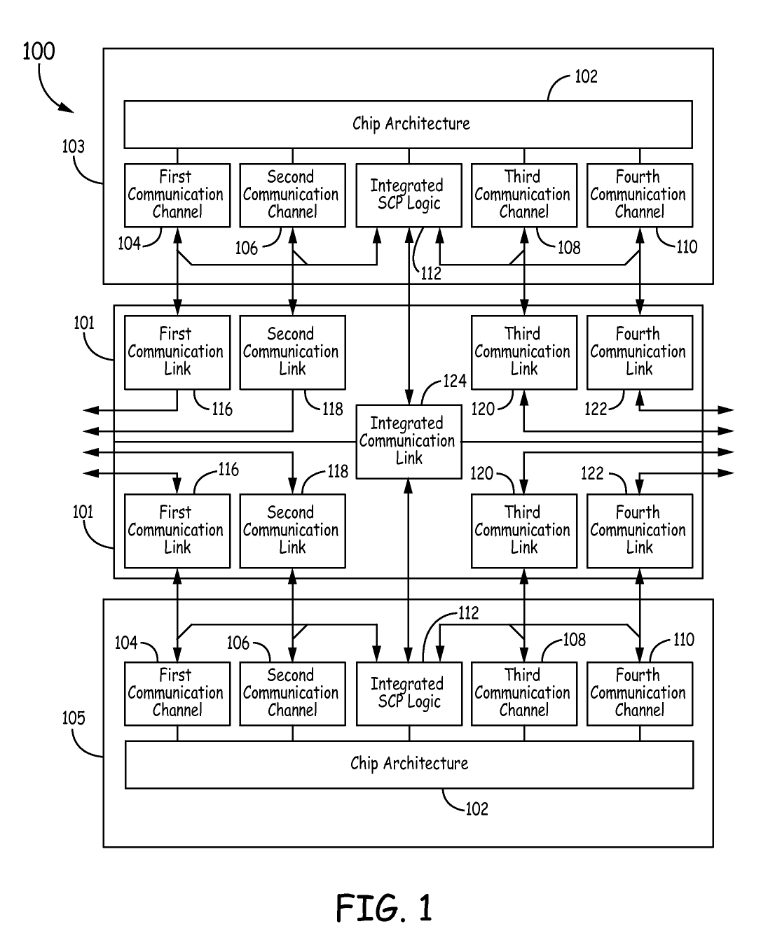

FIG. 1 is a block diagram of a SCP 100 that includes a first SoC 103 and a second SoC 105, where the first SoC 103 and the second SoC 105 are connected to a respective external interface 101, where each of the first SoC 103 and the second SoC 105 have a respective chip architecture 102. A SoC as described herein is an electrical system, such as a computer, that is integrated on a single die. The SoC may include commercially available field programmable gate arrays (FPGAs), multiple processors, an application-specific integrated circuit (ASIC), memory devices, and communication busses. In at least one implementation, the SoC communicates through different communication channels through the external interface 100 that is connected to the chip architecture 102. For example, in this embodiment, the chip architecture 102 in each of the first SoC 103 and the second SoC 105 is configured to communicate through a first communication channel 104, a second communication channel 106, a third communication channel 108, and a fourth communication channel 110. The different communication channels 104-110 communicate with devices that are connected to the SoC through a variety of communication formats. For example, the different communication channels may include PCIe 2.0, Spacewire, Ethernet, a local bus, Mil-Std 1553, RS-232, and the like. The different communication channels 104-110 communicate with external components through an associated communication link 116-122.

In certain implementations, the first SoC 103 and the second SoC 105 are part of a self-checking pair (SCP), where the SCP includes two identical, or functionally identical SoCs that are lock stepped together by a common clock or clock signal and/or signals that are communicated between the first SoC 103 and the second SoC 105. Alternatively, the first SoC 103 and the second SoC 105 are part of a system comprising multiple SoCs. As the SoCs in the SCP are functionally identical, each of the first SoC 103 and the second SoC 105 transmit the same information through each of the communication channels 104-110. In certain implementations, to verify that the output through the different communication channels 104-110, from each SoC in the SCP, is identical, each of the first SoC 103 and the second SoC 105 includes an integrated SCP logic 112. The integrated SCP logic 112 on the first SoC 103 communicates with a similar integrated SCP logic 112 on the second SoC 105. The integrated SCP logic 112 verifies that the first SoC 103 and the second SoC 105 are sending the same data through the different communication channels 104-110 by receiving the data from the different communication channels 104-110 and transmitting the data to the other SoC in the SCP. Thus, on the first SoC 103, when the first communication channel 104 transmits a message through the first communication link 116, the first communication channel 104 also transmits the same message to the integrated SCP logic 112. The integrated SCP logic 112 then transmits the message received from the first communication channel 104 to the integrated SCP logic 112 located on the second SoC 105 through the integrated communication link 124, where the integrated communication link 124 includes a communication medium between the first SoC 103 and the second SoC 105. For example, the integrated communication link 124 may be an Ethernet connection, a data bus and the like. Also, the integrated SCP logic 112 on the first SoC 103 receives data from the second SoC 105 in the SCP 100. The integrated SCP logic 112 on the first SoC 103, upon receiving the data from the second SoC 105, compares the received data against the transmitted data to verify that the information being transmitted from both the first SoC 103 and the second SoC 105 in the SCP 100 is approximately identical, where information is approximately identical when it is interpreted in the same way by different SoCs.

In at least one embodiment, when an integrated SCP logic 112 determines that the first SoC 103 and the second SoC 105 have transmitted non-identical data, the integrated SCP logic 112 on either or both the first SoC 103 or the second SoC 105 sends a signal to the other SoC to instruct the other SoC to stop transmitting data through the different communication channels 104-110. In certain implementations, the integrated SCP logic 112 sends a signal to the other SoC instructing the other SoC to stop transmitting data through a particular communication channel in the different communication channels 104-110. In another implementation, the integrated SCP logic 112 notifies a user that one SoC in the SCP has compared two messages and found non-identical data. In a further implementation, the integrated SCP logic 112 resets both the first SoC 103 and the second SoC 105 in the SCP 100 upon the identification of non-identical data. Thus, the integrated SCP logic 112 functions to prevent SoCs in an SCP from providing different data.

In a further embodiment, input data streams that are received through the different communication channels 104-110 may also be synchronized such that different SoCs receive the input data at the same time. To synchronize the input streams processors on the different SoCs in the SCP 100 use cross-side signaling, where, data bus accesses by a processor on the first SoC 103 and the second SoC 105 are synchronized with one another.

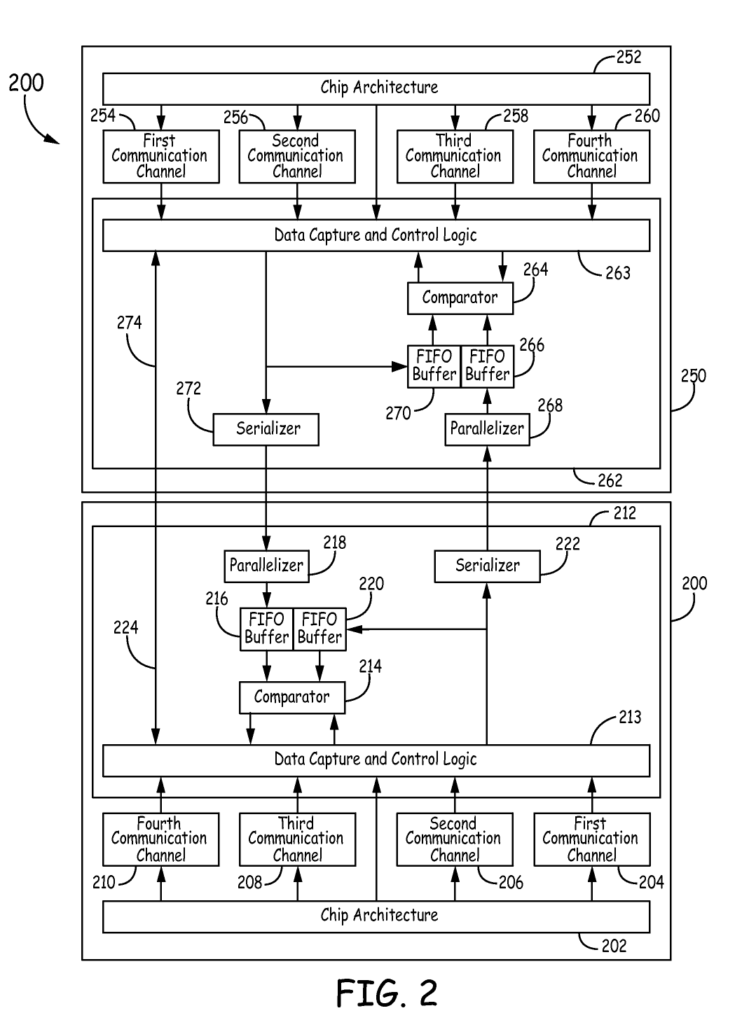

FIG. 2 is a simplified block diagram illustrating the integrated SCP logic 212, 262 in an exemplary SCP comprised of first SoC 200 and second SoC 250. As described above, as the first SoC 200 and the second SoC 250 are part of an SCP, the first SoC 200 and the second SoC 250 are functionally identical. As shown, the first SoC 200 includes different communication channels 204-210 that, in certain embodiments, function like the different communication channels 104-110 in FIG. 1. Likewise, the second SoC 250 includes different communication channels 254-260 that function like the different communication channels 104-110 in FIG. 1. As described above, each of the different communication channels 204-210 and 254-260 transmit signals to an external device in a larger system. Further, each of the different communication channels 204-210 and 254-260 transmit the same signals that are sent to an external device to the integrated SCP logic 212 and 262 in the associated SoC.

In certain implementations, the first integrated SCP logic 212 in the first SoC 200 includes the integrated SCP logic 212. In certain implementations, the first integrated SCP logic 212 functions similarly to the integrated SCP logic 112 in FIG. 1. In one exemplary implementation of the integrated SCP logic, the first integrated SCP logic 212 includes a data capture and control logic 213. The data capture and control logic 213 receives the data from the different communication channels 204-210 and provides it to a serializer 222 and first in first out (FIFO) buffer 220. In certain implementations, the data capture and control logic 213 provides the data to multiple FIFO buffers, where each buffer is associated with a different communication channel. Also, in an alternative embodiment, the data capture and control logic 213 transmits the data received from the different communication channels 204-210 to the SoC 250 across a parallel bus. When the data capture and control logic 213 receives the data from the different communication channels 204-210, the data capture and control logic 213 preserves the original formatting of the data received from the different communication channels 204-210. Further, the data capture and control logic 213 transmits the data to the serializer 222 and FIFO buffer 220 in the order that it was received. For example, when the data capture and control logic 213 receives a first data packet from the first communication channel 204 in a first frame format and subsequently receives a second data packet from the second communication channel 208 in a second frame format, the data capture and control logic 213 will transmit the first data packet to the serializer 222 in the first frame format and then transmit the second data packet to the serializer 222 in the second frame format. In a similar manner, the data capture and control logic 263 in the second SoC 250 receives data packets from the different communication channels 254-260 and transmits the data packets to the serializer 272 in the second SoC 250.

In at least one embodiment, upon receiving the data packets from the data capture and control logic 213, the serializer 222 serializes the data packets for transmission to the second SoC 250 in the SCP. In certain implementations, the data capture and control logic 213 transmits parallel data to the serializer 222. Upon reception of the parallel data, the serializer 222 arranges the data in serial form for transmission to another SoC, such as SoC 250 in the SCP. By serializing the data, information can be transmitted between the different SoCs 200 and 250 in the SCP across a single serial bus, thus reducing the number of pins needed for communication between the different SoCs 200 and 250 in the SCP. When the serial data stream is transmitted from the first SoC 200 to the other SoC 250 in the SCP, the other SoC 250 receives the data at a parallelizer 268 that parallelizes the serial data stream for placement in a FIFO buffer 266. In a similar manner, the serializer 272 transmits a serial data stream from SoC 250 to the parallelizer 218 on SoC 200. Likewise, the parallelizer 218 parallelizes a serial data stream and transmits the parallel data stream to a FIFO buffer 216. In at least one alternative implementation, the SoCs 200 and 250 communicate with each other across a parallel bus.

In certain implementations, each integrated SCP logic 212 and 262 on respective SoCs 200 and 250 contains at least two FIFO buffers. For example, the integrated SCP logic 212 contains FIFO buffer 216 and FIFO buffer 220. The FIFO buffer 216 receives parallel data packets from SoC 250 through the parallelizer 218 and the FIFO buffer 220 receives data packets from the data capture and control logic 213. FIFO buffers 216 and 220 may receive the data packets at different times, but, when the SoCs are functioning correctly, identical data packets are received in the same order. Therefore, the first data packet in each of the FIFO buffers 216 and 220 are identical to one another. Each FIFO buffer 216 and 220 then provides the data packets that have been stored for the longest period of time to a comparator 214. In certain implementations, FIFO buffer 270 functions like FIFO buffer 220 and FIFO buffer 266 functions like FIFO buffer 216.

To verify that the SoC 200 functions identically to the SoC 250, the integrated SCP logic 212 compares data packets received from the FIFO buffers 220 and 216 to verify that the data packets that are provided by the FIFO buffers 220 and 216 are identical. For example, FIFO buffers 220 and 216 are initially empty and the SoC 200 produces a data packet for transmission through one of the different communication channels 204-210. The data capture and control logic 213 receives the data packet and passes it to the FIFO buffer 220. At substantially the same time, the second SoC 250 transmits a data packet to the first SoC 200. The first SoC 200 places the data packet into the FIFO buffer 216. As the data packet from the data capture and control logic 213 is the first data packet in the FIFO buffer 220 and the data packet from the second SoC 250 is the first data packet in the FIFO buffer 216, the FIFO buffers 220 and 216 then pass the data packets to the comparator 214. The comparator 214 verifies that the data packets are identical. When the data packets are identical, the comparator 214 indicates to the data capture and control logic 213 that the packets were identical by transmitting a valid signal to the data capture and control logic 213. When the comparator 214 compares packets that are not identical, the comparator 214 sends an invalid signal to the data capture and control logic 213. In certain situations, the data capture and control logic 213 may disable the comparator 214 to prevent the comparator 214 from comparing signals transmitted from the second SoC 250 to signals transmitted from the first SoC 200. In certain situations, the comparator 264 functions similarly to comparator 214.

In at least one embodiment, when the data capture and control logic 213 receives an invalid signal from the comparator 214, the data capture and control logic 213 transmits a cross side inhibit signal 224 to the second SoC 250. In at least one implementation, the data capture and control logic 213 interprets a received invalid signal as indicating that the second SoC 250 is not functioning correctly. To prevent the second SoC 250 from sending erratic data to external systems through the different communication channels 204-210. The data capture and control logic 213 send the cross side inhibit signal 224 to the data capture and control logic 263 on the second SoC 250. When the data capture and control logic 263 receives the cross side inhibit signal 224 from the first SoC 200, the data capture and control logic 263 may stop the transmission of any signals from the second SoC 250 through the different communication channels 204-210.

In an alternative implementation, when the data capture and control logic 213 receives an invalid signal from the comparator 214, the data capture and control logic 213 sends a cross side inhibit signal 224 to the second SoC 250, whereupon both the first SoC 200 and the second SoC 250 reset and reinitialize communications between the first SoC 200 and the second SoC 250. In a further implementation, when the data capture and control logic 213 sends the cross side inhibit signal 224, the data capture and control logic 213 also includes information that identifies the communication channel in the different communication channels 204-210 from which the data packet was sent that caused the comparator 214 to produce the invalid signal. Upon reception of the cross side inhibit signal, the data capture and control logic 263 may disable communication through the particular communication channel that is producing the particular errors. In a similar manner, the data capture and control logic 213 responds to cross side inhibit signal 274 received from the data capture and control logic 263. Because the data capture and control logic 213 and 263 are able to verify that the first SoC 200 and the second SoC 250 are transmitting identical data packets at substantially the same time, the first SoC 200 and the second SoC 250 form a SCP that prevents either the first SoC 200 or the second SoC 250 from sending erratic data.

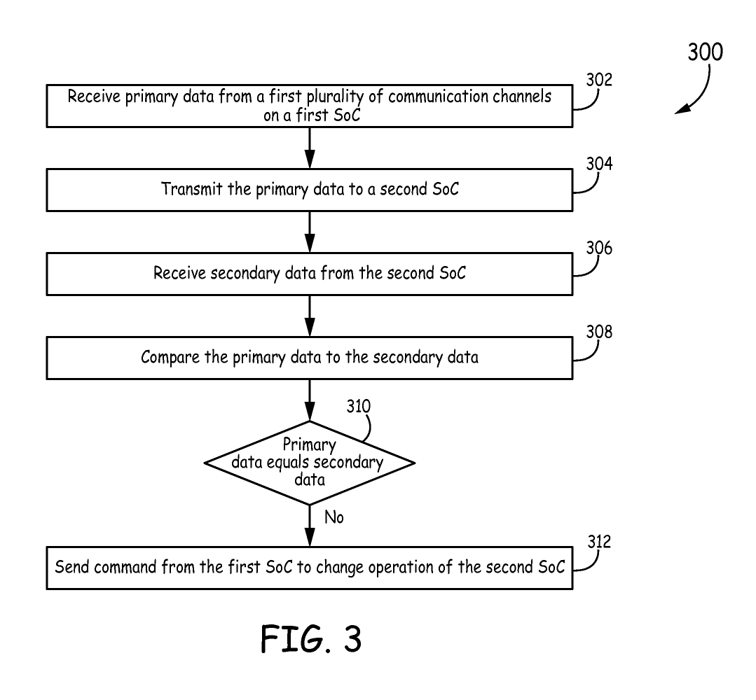

FIG. 3 is a flow diagram illustrating a method 300 for synchronizing the operation of two SoCs that are in a SCP. Method 300 proceeds at 302 where primary data is received from a first plurality of communication channels on a first SoC. For example, an integrated SCP logic captures the data that is transmitted from a plurality of communication channels on a first SoC to an external system. Method 300 proceeds at 304 where the primary data is transmitted to a second SoC. When the primary data is captured by the integrated SCP logic, the integrated SCP logic transmits the primary data to a second SoC. In at least one implementation, the integrated SCP logic serializes the data before transmitting the data to the second SoC. Further, the integrated SCP logic stores the primary data in a transmit FIFO buffer.

Method 300 proceeds at 306 where the secondary data is received from the second SoC. In at least one implementation, when the first SoC is gathering the primary data, a second SoC is producing secondary data that should be identical to the primary data. In a similar manner to the transmission of the primary data to the second SoC by the first SoC, the second SoC transmits the secondary data to the first SoC. In one implementation, first SoC parallelizes the secondary data and stores the secondary data in a receive FIFO buffer.

Method 300 proceeds at 308, where the primary data is compared to the secondary data. In at least one exemplary implementation, the integrated SCP logic in the first SoC compares the primary data stored in the transmit FIFO buffer with the secondary data stored in the receive FIFO buffer. Method 300 proceeds at 310 where the first SoC determines whether the primary data equals the secondary data. When the primary data does not equal the secondary data, the method 300 proceeds to 312 where a command is sent from the first SoC to change the operation of the second SoC. For example, when the primary data is not equal to the secondary data, the first SoC may transmit a cross side inhibit signal to the second SoC, which will command the second SoC to not transmit data through any external communication channels. Alternatively, the cross side inhibit signal may command the second SoC to stop transmitting over a portion of the external communication channels. In a further implementation, both the first SoC and the second SoC may both reset upon the generation of cross side inhibit signal by either the first SoC or the second SoC.

### EXAMPLE EMBODIMENTS

Example 1 includes a system on chip, the system on chip comprising: a system architecture; a plurality of communication channels configured for communicating data with an external system; and an integrated system on chip logic configured to collect the data communicated through the plurality of communication channels and transmit the data to a second system on chip and handle received data from the second system on chip, wherein the integrated system on chip logic determines whether the data communicated through the plurality of communication channels matches the received data from the second system on chip.

Example 2 includes the system on chip of Example 1, wherein the integrated system on chip logic comprises: a data capture and control logic configured to collect the data communicated through the plurality of communication channels; and a comparator configured to determine whether the data matches the received data.

Example 3 includes the system on chip of Example 2, wherein the integrated system on chip logic comprises: a serializer that transmits the data as the data is received from the data capture and control logic in a serial bit stream; and a parallelizer configured to convert the received data that is received as a serial bit stream into a parallel data stream.

Example 4 includes the system on chip of any of Examples 2-3, wherein the integrated system on chip logic further comprises: at least one transmit first in first out (FIFO) buffer configured to store the data as the data is received from the data capture and control logic; and at least one receive FIFO buffer configured to store the received data in the parallel data stream.

Example 5 includes the system on chip of Example 4, wherein each transmit FIFO buffer in the at least one transmit FIFO buffers is associated with a communication channel in the plurality of communication channels.

Example 6 includes the system on chip of any of Examples 2-5, wherein the data capture and control logic provides an enable signal to the comparator, wherein the enable signal indicates to the comparator whether to compare the data against the received data.

Example 7 includes the system on chip of any of Examples 2-6, wherein the data capture and control logic provides a cross side inhibit to the second system on chip when the comparator determines that the data does not match the received data, wherein the cross side inhibit directs the second system on chip to disable a portion of the communication between the second system on chip and the external system.

Example 8 includes the system on chip of any of Examples 2-7, wherein the data capture and control logic is configured to process a received cross side inhibit from the second system on chip, wherein, upon the reception of the received cross side inhibit, the data capture and control logic performs at least one of: disabling communication through the plurality of communication channels; disabling a portion of the communication through the plurality of communication channels; and resetting the system on chip and the second system on chip.

Example 9 includes the system on chip of any of Examples 1-8, wherein the system on chip and the second system on chip are both synchronized to a clock signal.

Example 10 includes a self checking pair, the self checking pair comprising a first system on chip, the first system on chip comprising: a first system architecture; a first plurality of communication channels configured for communicating primary data with an external system; and a first integrated system on chip logic configured to collect the primary data communicated through the first plurality of communication channels; and a second system on chip, the second system on chip comprising: a second system architecture; a second plurality of communication channels configured for communicating secondary data with an external system; and a second integrated system on chip logic configured to collect the secondary data communicated through the second plurality of communication channels and transmit the secondary data to the first system on chip and handles the primary data from the first system on chip, wherein the second integrated system on chip logic determines whether the secondary data matches the primary data; and wherein the first integrated system on chip logic transmits the primary data to the second system on chip and handles the secondary data from the second system on chip, wherein the first integrated system on chip logic determines whether the primary data matches the secondary data.

Example 11 includes the self checking pair of Example 10, wherein the first integrated system on chip logic comprises: a first data capture and control logic configured to collect the primary data communicated through the first plurality of communication channels; and a first comparator configured to determine whether the primary data matches the secondary data; and wherein the second integrated system on chip logic comprises a second data capture and control logic configured to collect the secondary data communicated through the second plurality of communication channels; and a secondary comparator configured to determine whether the secondary data matches the primary data.

Example 12 includes the self checking pair of Example 11, wherein the first integrated system on chip logic comprises: a first serializer that transmits the primary data in a primary serial bit stream as the primary data is received from the first data capture and control logic; and a first parallelizer configured to convert the secondary data that is received as a secondary serial bit stream into a secondary parallel data stream; and wherein the second integrated system on chip logic comprises: a second serializer that transmits the secondary data in the secondary serial bit stream as the secondary data is received from the secondary data capture and control logic; and a second parallelizer configured to convert the primary data that is received as a primary serial bit stream into a primary parallel data stream.

Example 13 includes the self checking pair of any of Examples 11-12, wherein the first data capture and control logic is configured to handle a second cross side inhibit from the second data capture and control logic, wherein, upon the reception of the second cross side inhibit, the first data capture and control logic performs at least one of: disabling communication through the first plurality of communication channels; disabling a portion of the communication through the plurality of communication channels; and resetting the first system on chip and the second system on chip.

Example 14 includes the self checking pair of any of Examples 11-13, wherein the first data capture and control logic provides an enable signal to the first comparator, wherein the first enable signal indicates to the first comparator whether to compare the primary data against the secondary data.

Example 15 includes the self checking pair of any of Examples 11-14, wherein the first data capture and control logic provides a first cross side inhibit to the second system on chip when the comparator determines that the primary data does not match the secondary data, wherein the cross side inhibit directs the second system on chip to disable a portion of the communication through the second plurality of communication channels.

Example 16 includes the self checking pair of any of Examples 10-15, wherein primary data accesses of primary communication data received through the first plurality of communication channels on the first system on chip are synchronized with secondary data accesses of secondary communication data received through the second plurality of communication channels on the second system on chip.

Example 17 includes a method for synchronizing a self-checking pair, the method comprising: receiving primary data from a first plurality of communication channels on a first system on chip; transmitting the primary data to a second system on chip; receiving secondary data from the second system on chip, wherein the secondary data is produced by a second plurality of communication channels; comparing the primary data to the secondary data; and when the primary data fails to match the secondary data, sending a command from the first system on chip to change operation of the second plurality of communication channels on the second system on chip.

Example 18 includes the method of Example 17, wherein transmitting the primary data to a second system on chip comprises: collecting the primary data from the first plurality of communication channels; storing the primary data in at least one transmit first in first out (FIFO) buffer; and serializing the primary data.

Example 19 includes the method of any of Examples 17-18, wherein receiving secondary data from the second system on chip comprises: parallelizing the secondary data; and storing the parallelized data in at least one receive FIFO buffer.

Example 20 includes the method of any of Examples 17-19, wherein the operation of the second plurality of communication channels is changed by at least one of: disabling communication through the first plurality of communication channels; disabling a portion of the communication through the plurality of communication channels; and resetting the first system on chip and the second system on chip.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A system on chip, the system on chip comprising:
a system architecture;
a plurality of communication channels configured for communicating data with an external system; and
an integrated system on chip logic configured to collect the data communicated through the plurality of communication channels and transmit the data to a second system on chip and handle received data from the second system on chip, wherein the integrated system on chip logic determines whether the data communicated through the plurality of communication channels matches the received data from the second system on chip.

2. The system on chip of claim 1, wherein the integrated system on chip logic comprises:
a data capture and control logic configured to collect the data communicated through the plurality of communication channels; and
a comparator configured to determine whether the data matches the received data.

3. The system on chip of claim 2, wherein the integrated system on chip logic comprises:
a serializer that transmits the data as the data is received from the data capture and control logic in a serial bit stream; and
a parallelizer configured to convert the received data that is received as a serial bit stream into a parallel data stream.

4. The system on chip of claim 2, wherein the integrated system on chip logic further comprises:
at least one transmit first in first out (FIFO) buffer configured to store the data as the data is received from the data capture and control logic; and
at least one receive FIFO buffer configured to store the received data in the parallel data stream.

5. The system on chip of claim 4, wherein each transmit FIFO buffer in the at least one transmit FIFO buffers is associated with a communication channel in the plurality of communication channels.

6. The system on chip of claim 2, wherein the data capture and control logic provides an enable signal to the comparator, wherein the enable signal indicates to the comparator whether to compare the data against the received data.

7. The system on chip of claim 2, wherein the data capture and control logic provides a cross side inhibit to the second system on chip when the comparator determines that the data does not match the received data, wherein the cross side inhibit directs the second system on chip to disable a portion of the communication between the second system on chip and the external system.

8. The system on chip of claim 2, wherein the data capture and control logic is configured to process a received cross side inhibit from the second system on chip, wherein, upon the reception of the received cross side inhibit, the data capture and control logic performs at least one of:
disabling communication through the plurality of communication channels;
disabling a portion of the communication through the plurality of communication channels; and
resetting the system on chip and the second system on chip.

9. The system on chip of claim 1, wherein the system on chip and the second system on chip are both synchronized to a clock signal.

10. A self checking pair, the self checking pair comprising
a first system on chip, the first system on chip comprising:
a first system architecture;
a first plurality of communication channels configured for communicating primary data with an external system; and
a first integrated system on chip logic configured to collect the primary data communicated through the first plurality of communication channels; and
a second system on chip, the second system on chip comprising:
a second system architecture;
a second plurality of communication channels configured for communicating secondary data with an external system; and
a second integrated system on chip logic configured to collect the secondary data communicated through the second plurality of communication channels and transmit the secondary data to the first system on chip and handles the primary data from the first system on chip, wherein the second integrated system on chip logic determines whether the secondary data matches the primary data; and
wherein the first integrated system on chip logic transmits the primary data to the second system on chip and handles the secondary data from the second system on chip, wherein the first integrated system on chip logic determines whether the primary data matches the secondary data.

11. The self checking pair of claim 10, wherein the first integrated system on chip logic comprises:
a first data capture and control logic configured to collect the primary data communicated through the first plurality of communication channels; and
a first comparator configured to determine whether the primary data matches the secondary data; and
wherein the second integrated system on chip logic comprises a second data capture and control logic configured to collect the secondary data communicated through the second plurality of communication channels; and
a secondary comparator configured to determine whether the secondary data matches the primary data.

12. The self checking pair of claim 11, wherein the first integrated system on chip logic comprises:
a first serializer that transmits the primary data in a primary serial bit stream as the primary data is received from the first data capture and control logic; and
a first parallelizer configured to convert the secondary data that is received as a secondary serial bit stream into a secondary parallel data stream; and
wherein the second integrated system on chip logic comprises:
a second serializer that transmits the secondary data in the secondary serial bit stream as the secondary data is received from the secondary data capture and control logic; and
a second parallelizer configured to convert the primary data that is received as a primary serial bit stream into a primary parallel data stream.

13. The self checking pair of claim 11, wherein the first data capture and control logic is configured to handle a second cross side inhibit from the second data capture and control logic, wherein, upon the reception of the second cross side inhibit, the first data capture and control logic performs at least one of:
disabling communication through the first plurality of communication channels;
disabling a portion of the communication through the plurality of communication channels; and
resetting the first system on chip and the second system on chip.

14. The self checking pair of claim 11, wherein the first data capture and control logic provides an enable signal to the first comparator, wherein the first enable signal indicates to the first comparator whether to compare the primary data against the secondary data.

15. The self checking pair of claim 11, wherein the first data capture and control logic provides a first cross side inhibit to the second system on chip when the comparator determines that the primary data does not match the secondary data, wherein the cross side inhibit directs the second system on chip to disable a portion of the communication through the second plurality of communication channels.

16. The self checking pair of claim 10, wherein primary data accesses of primary communication data received through the first plurality of communication channels on the first system on chip are synchronized with secondary data accesses of secondary communication data received through the second plurality of communication channels on the second system on chip.

17. A method for synchronizing a self-checking pair, the method comprising:
receiving primary data from a first plurality of communication channels on a first system on chip;
transmitting the primary data to a second system on chip;
receiving secondary data from the second system on chip, wherein the secondary data is produced by a second plurality of communication channels;
comparing the primary data to the secondary data; and
when the primary data fails to match the secondary data, sending a command from the first system on chip to change operation of the second plurality of communication channels on the second system on chip.

18. The method of claim 17, wherein transmitting the primary data to a second system on chip comprises:
collecting the primary data from the first plurality of communication channels;
storing the primary data in at least one transmit first in first out (FIFO) buffer; and
serializing the primary data.

19. The method of claim 17, wherein receiving secondary data from the second system on chip comprises:
parallelizing the secondary data; and
storing the parallelized data in at least one receive FIFO buffer.

20. The method of claim 17, wherein the operation of the second plurality of communication channels is changed by at least one of:
disabling communication through the first plurality of communication channels;
disabling a portion of the communication through the plurality of communication channels; and
resetting the first system on chip and the second system on chip.
